(19) United States
(12) Patent Application Publication
(10) Pub. No.: US 2007/0136955 A1
(43) Pub. Date: Jun. 21, 2007

(54) TEXTILE CONDITIONER WITH CLEANING AND ANTI-FUNGAL PROPERTIES

(75) Inventor: Ronnie Casey, New River, AZ (US)

Correspondence Address: SNELL & WILMER, LLP (Dial Corp), ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 11/610,887

(22) Filed: Dec. 14, 2006

Related U.S. Application Data
(60) Provisional application No. 60/597,656, filed on Dec. 15, 2005.

(51) Int. Cl. C11D 3/00

(52) U.S. Cl. 8/115.51

(57) ABSTRACT

A composition for conditioning and cleansing textiles, especially leather, is provided. Furthermore, the composition has anti-bacterial and anti-fungal properties.

### CROSS-REFERENCE TO RELATED APPLICATIONS

This application claims priority to U.S. Provisional Patent Application Ser. No. 60/597,656, filed Dec. 15, 2005, entitled “Textile Conditioner with Cleaning and Anti-Fungal Properties.”

### FIELD OF INVENTION

The present invention is generally directed towards textile conditioners and cleaners. More particularly, the present invention is directed towards a textile conditioner composition with cleaning and anti-fungal and anti-microbial properties suitable for application to leather.

### BACKGROUND OF THE INVENTION

Many textiles, especially leather in its various forms and materials with properties similar to leather, are difficult to keep conditioned on a daily basis. As an example, leather is a strong supple material that is used in a wide variety of applications, for example, clothing, shoes, belts, briefcases, helmets, gloves, pants, horse bridles and reins, saddles, gear belts, musical instruments, books, furniture, sporting goods, and the like. Although leather is used for many rugged applications, its natural fibers will begin to deteriorate, especially in the presence of moisture or direct sunlight. When exposed to water or sunlight, the leather may tend to discolor, shrink, or plasticize causing the material to become rigid, brittle and lose its usefulness.

With proper care, leather's useful lifetime can be dramatically extended. When a leather item is created, oils are sometimes used to supplement the natural oils of the leather to improve its resistance to various elements. However, these oils deteriorate through repeated exposure. The leather items can be re-oiled but the process is time-consuming, messy, and does not necessarily keep the item clean. In other words, re-oiling an item does not remove dirt and grime, odors, bacteria, or other substances. Consequently, one needs to have the item cleaned before re-oiling in order to maintain the benefits of leather, which further contributes to the inconvenience of owning and maintaining leather. Although leather is used as an example, this type of deterioration and cleaning process is similar with other textiles.

Thus, there is a need for a textile product that is convenient to use, helps prolong the life of these items, and provides a suitable conditioning effect that cleans, removes dirt, and counteracts microbial and fungal growth.

### SUMMARY OF THE INVENTION

While the way in which the present invention address the disadvantages of the prior art will be discussed in greater detail below, in general, the present invention provides a textile conditioning composition that effectively conditions and cleans the textile while enabling the textile to withstand and counteract microbes and fungi. One application of the composition is conditioning and cleaning leather items. In accordance with various embodiments of the present invention, the textile conditioning composition comprises a conditioner, a cleaner, an opening agent, an anti-microbial and/or anti-fungal, a carrier, and optional ingredients.

### DETAILED DESCRIPTION

The following descriptions are of exemplary embodiments of the invention only, and are not intended to limit the scope or applicability of the invention in any way. Rather, the following description is intended to provide convenient illustrations for implementing various embodiments of the invention. As will become apparent, various changes may be made in the compositions described in these embodiments without departing from the spirit and scope of the invention.

In accordance with various aspects of the present invention, a textile conditioning composition that effectively conditions and cleans the textile while providing anti-microbial and/or anti-fungal effects is provided. In accordance with various embodiments of the present invention, the textile conditioning composition variously comprises a conditioner, a cleanser or detergent, an opening agent, a carrier, an anti-microbial agent and optional ingredients, for example, fragrance, dyes, preservatives, etc. In accordance with various embodiments, the composition is used to condition leather in any of its forms.

In accordance with one aspect of the present invention, the textile conditioning composition conditions the textile so that the textile remains supple and thereby lengthens its useful life. For example, in accordance with various embodiments the textile conditioning composition comprises a humectant present in amounts up to about 75 percent, and in a preferred embodiment, from about 40 percent to about 50 percent by weight of the textile conditioning composition.

Humectants are hygroscopic substances and are often used as a moisturizer. It is often a molecule with several hydrophilic groups, most often hydroxyl groups, but amines and carboxyl groups, sometimes esterified, may be encountered as well. Humectants are generally characterized as a material that has an affinity to form hydrogen bonds with molecules of water, thereby providing the moisturizing effect.

In accordance with a preferred embodiment, the humectant is glycerin.

However, any humectant, such as glycerine, propylene glycol, glyceryl triacetate, polyols, such as sorbitol, xylitol, and maltitol, or polymeric polyols, like polydextrose, or natural extracts like quillaia, or lactic acid or urea, or other humectants now known or hereafter devised that are able to condition textiles, especially leather, are suitable for use.

In accordance with another aspect of the present invention, the textile cleaning composition cleanses the textile by lifting dirt and other contaminants from the surface. For example, in accordance with various embodiments, the textile cleaning composition comprises a mild cleanser or detergent present in the amount from about 0.1 percent to about 2 percent by weight. The mild detergent should be strong enough to clean the textile's fibers but gentle enough as not to counter the effects of the conditioner and dry out the surface of the textile. In accordance with various embodiments, the mild detergent may comprise soap, shampoo, and/or betaines.

In accordance with another aspect of the present invention, the textile conditioning composition prevents the growth and reproduction of various microorganisms on the textile's surface. For example, the composition may destroy bacteria and/or fungi upon application of the composition to the surface of the textile. Additionally, through repeated use of the composition, the textile will be able to withstand and counteract microbial and fungal growth. For example, in accordance with various embodiments of the present invention, the textile conditioning composition comprises an anti-microbial agent effective against bacteria and fungi present. An agent, such as Borax, may be used in the amount of about 0.1 percent to about 5 percent by weight of the composition. More preferably, the anti-microbial agent is present in the amount of about 0.1 percent to about 3 percent, and optimally the agent is present in the amount of about 0.5 percent to about 2 percent by weight of the composition. As noted above, preferably, the anti-microbial agent is Borax, however any substance capable of providing antiseptic benefits is suitable as long as it is compatible with the conditioning and cleansing components of the composition.

In accordance with another aspect of the present invention, the textile conditioning composition prepares the surface of the textile so that it accepts the conditioning and antiseptic agents. By “opening up” the textile surface, the conditioner can penetrate the textile fibers without leaving behind a tacky residue. In accordance with various embodiments of this aspect of the invention, the textile cleaning composition comprises an opening agent present in the amount from about 40 percent to about 50 percent by weight. In preferred embodiments of the present invention, the opening agent is water. However, any substance capable of preparing the textile's surface to receive the conditioning and cleansing agents is suitable.

In accordance with another aspect of the present invention, the textile conditioning composition comprises a suitable carrier. Preferably, the carrier is present to make up the balance of the composition and should not interfere with the conditioning and cleansing effects of the composition.

In accordance with various embodiments of this aspect of the present invention, the carrier is water. In some embodiments the carrier and the opening agent are the same component, for example water. However, there is no requirement that this component and the opening agent must be the same chemical.

In accordance with various embodiments of the present invention, the textile conditioning composition may be configured for a variety of particular end-use purposes. Any additional ingredients may be added to the textile cleaning composition; however, these optional ingredients should not interfere with conditioning and cleansing effects of the composition nor cause deterioration of the textile's fibers. For example, textile conditioning compositions in accordance with the present invention may comprise one or more of a preservative, a fragrance, or a color adjuster.

In accordance with the various exemplary embodiments, an optional, solubilized preservative may be added to the composition of the present invention. Preferred levels of the preservative, when present, are up to about 1.0% by weight of the composition.

It is preferable to utilize a preservative that is effective to inhibit and/or control both bacteria and fungi, and such inhibition and control advantageously supplements the anti-microbial effect of the composition. In accordance with an aspect of an exemplary embodiment of the present invention, an effective amount of Dantogard® preservative, available from Lonza Group of Switzerland, may be used. Additional suitable preservatives may include any organic preservative that will not adversely affect or damage textile articles. Preferred water-soluble preservatives include, for example, glutaraldehyde halogenated compounds, hydantoin compounds, organic sulfur compounds, low molecular weight aldehydes, benzalkonium chlorides, alkylarylsulfonates, halophenols, cyclic organic nitrogen compounds, quaternary compounds, dehydroacetic acid, phenyl and phenoxy compounds.

Dyes and fragrances may, in accordance with various exemplary embodiments of the present invention, be added to the composition of the invention in order to enhance the esthetic appeal of the product and to provide the consumer with not only the conditioning performance but also a visually and sensorially “typical and unmistakable” product. The dyes may be included as part of the composition to assist with covering unsightly cracks in damaged or worn portions of a textile, such as leather.

As perfume oils and/or fragrances it is possible to use individual odorant compounds, examples being the synthetic products of the ester, ether, aldehyde, ketone, alcohol and hydrocarbon types. Preference, however, is often given to using mixtures of different odorants, which together produce an appealing fragrance. Such perfume oils may also contain natural odorant mixtures, as are obtainable from plant sources.

In accordance with another aspect of the present invention, while the composition of the present invention generally provides for a liquid composition, the present invention may also be configured to exhibit a solid form, such as a solid glycerin type bar, for example, by adding tallow.

Finally, it should be understood that various principles of the invention have been described in illustrative embodiments. However, many combinations and modifications of the above-described formulation, proportions, elements, materials and components, used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered.

I claim:

1. A composition for conditioning textiles comprising:
a humectant up to about 75% by weight;
a cleansing detergent from about 0.1% to about 2% by weight;
an anti-microbial agent from about 0.1% to about 5% by weight;
an opening agent from about 40% to about 50% by weight; and
a carrier.

2. The composition of claim 1, wherein said humectant comprises from about 40% to about 50% by weight of the composition.

3. The composition of claim 2, wherein said humectant comprises glycerin.

4. The composition of claim 1, wherein said anti-microbial agent comprises from about 0.1% to about 3% by weight of the composition.

5. The composition of claim 4, wherein said anti-microbial agent comprises from about 0.5% to about 2% by weight of the composition.

6. The composition of claim 5, wherein said anti-microbial agent comprises borax.

7. The composition of claim 1, wherein said opening agent comprises water.

8. The composition of claim 1, further comprising a fragrance.

9. The composition of claim 8, further comprising a preservative.

10. The composition of claim 9, further comprising a color adjustor.

11. A composition for conditioning textiles comprising:
glycerin from about 40% to about 50% by weight;
a cleansing detergent from about 0.1% to about 2% by weight;
borax from about 0.5% to about 2% by weight;
water from about 40% to about 50% by weight; and
a carrier.

12. The composition of claim 11 further comprising at least one from the following, a fragrance, a preservative, and a color adjustor.
